(19) United States
(12) Patent Application Publication
(10) Pub. No.: US 2013/0181915 A1
(43) Pub. Date: Jul. 18, 2013

(54) TOUCH DISPLAY, COMPUTER SYSTEM HAVING A TOUCH DISPLAY, AND METHOD OF SWITCHING MODES OF A TOUCH DISPLAY

(71) Applicant: Feng-Yuan Chen, New Taipei City (TW)

(72) Inventor: Feng-Yuan Chen, New Taipei City (TW)

(21) Appl. No.: 13/541,778

(22) Filed: Jul. 5, 2012

(30) Foreign Application Priority Data
Jan. 13, 2012 (TW) 101101350

(51) Int. Cl. G06F 3/041

(52) U.S. Cl. 345/173

(57) ABSTRACT

A touch display capable of switching modes is disclosed in the present invention. The touch display includes a touch panel, an image controller electrically connected to the touch panel, a switch, and a touch signal processor electrically connected to the touch panel, the image controller and the switch. The touch panel generates a touch signal according to a plurality of blocks triggered on the touch panel. The image controller receives an image signal outputted from a host and drives the touch panel to display a corresponding image. The switch can be used to switch the touch signal processor to a first operating mode or a second operating mode. The touch signal processor receives the touch signal, and transmits the touch signal to the image controller or to the host according to the mode switched by the switch.

### BACKGROUND OF THE INVENTION

1. Field of the Invention

The present invention relates to a touch display, and more particularly, to a touch display capable of switching operating modes, and to a related computer system and an operating method.

2. Description of the Prior Art

A conventional touch display can be an external display device of a host, a user can control application program of the host by a touch panel of the touch display. The conventional touch display includes the touch panel, an image controller and a touch signal processor. The touch panel displays an image provided by the image controller. The image controller is electrically connected to the touch panel and the host for receiving a command outputted from the host, so as to drive the touch panel to display the image. The touch signal processor is electrically connected between the touch panel and the host. When the touch panel is pressed, the touch signal processor receives a touch signal generated from the touch panel, and transmits the touch signal to the host. The host can output a command to the image controller according to the touch signal, so as to drive the touch panel to display the corresponding image.

The host includes a memory unit for storing a table. The table includes relation between coordinates of the touch panel and actuating information, and each coordinates corresponds to the specific actuating information. For example, the coordinate information (220, 120) can correspond to the actuating information “an enter command”, and the coordinate information (220, 240) can correspond to the actuating information “a cancel command”. The touch panel is pressed to generate the touch signal, and the touch signal represents coordinate information of a point on the touch panel where the user presses. The touch signal processor receives and transmits the touch signal to the host, so as to utilize a central processing unit of the host to analyze the actuating information according to the touch signal (the coordinate information). When the coordinate information (220, 120) on the touch panel is pressed, the host analyzes that the touch signal corresponds to the enter command, so the host executes the enter operation and shows the result on the touch display via the image controller. When the pressing point on the touch panel is not (220, 120) and (220, 240), the host determines that neither the enter command nor the cancel command is actuated, the host does not execute the corresponding operation, and the touch panel does not change the image by the image controller.

Generally, the conventional touch display can be applied to ATM, a tour guide machine, a network commerce machine and so on. The image controller of the conventional touch display drives the touch panel to display the predetermined image according to the commands from the host, and the table including the relation between the coordinates and the actuating information is stored in the memory of the host. When the touch panel is pressed, the touch signal processor receives the touch signal (the coordinate information of the pressing point), and directly transmits the touch signal to the host. The CPU of the host analyzes the touch signal and the related actuating information and drives the touch panel to display the corresponding image via the image controller.

Therefore, the touch signal processor of the conventional touch display is a bridging unit between the touch panel and the host. The touch signal processor does not transmit information to the image controller in the conventional touch display. An operating system of the common host may not support virtual keyboard function, so that an external keyboard device is necessary to electrically connect to the host with the conventional touch display, or the conventional touch display has to collocate with the host that installs the specific operating system supporting the virtual keyboard function. Design of a touch display capable of applying to the host that installs the operating system without the virtual keyboard function, and being switched to virtual keyboard interface or conventional touch interface according to actual demand is an important issue in the display industry.

### SUMMARY OF THE INVENTION

The present invention provides a touch display capable of switching operating modes, and a related computer system and operating method for solving above drawbacks.

According to the claimed invention, a touch display includes a touch panel for generating a touch signal according to a triggered area on the touch panel, an image controller electrically connected to the touch panel for receiving an image signal outputted from a host and driving the touch panel to display a corresponding image, a switch, and a touch signal processor electrically connected to the touch panel, the image controller and the switch. The touch signal processor is switched to a first operating mode and to a second operating mode by the switch, the touch signal processor receives the touch signal and transmits the touch signal to the image controller and to the host according to the operating mode.

According to the claimed invention, the touch display further includes a signal adapter electrically connected to the touch signal processor, the image controller and the host.

According to the claimed invention, the touch signal processor transmits the touch signal to the image controller in the first operating mode, the image controller transforms the touch signal into a corresponding input signal, and transmits the input signal to the host via the signal adapter.

According to the claimed invention, the image controller is electrically connected to the switch for driving the touch panel to display a virtual keyboard pattern when the touch signal processor is switched to the first operating mode.

According to the claimed invention, the touch display further includes a memory electrically connected to the image controller, the memory storing the virtual keyboard pattern.

According to the claimed invention, the touch signal is coordinate information, and the input signal is character information corresponding to the virtual keyboard pattern.

According to the claimed invention, the touch signal processor transmits the touch signal to the host via the signal adapter in the second operating mode.

According to the claimed invention, a computer system includes a host for outputting an image signal, and a touch display for displaying an image according to the image signal outputted from the host. The touch display includes a touch panel for generating a touch signal according to a triggered area on the touch panel, an image controller electrically connected to the touch panel for receiving the image signal and driving the touch panel to display the image, a switch, and a touch signal processor electrically connected to the touch panel, the image controller and the switch. The touch signal processor is switched to a first operating mode and to a second operating mode by the switch, the touch signal processor receives the touch signal and transmits the touch signal to the image controller and to the host according to the operating mode. The host outputs the image signal corresponding to the touch signal to the image controller.

According to the claimed invention, an operating system of the host does not support a virtual keyboard function.

According to the claimed invention, a method of switching operating modes of the touch display includes switching a touch signal processor to a predetermined operating mode, displaying a virtual keyboard pattern on a touch panel when the touch signal processor is switched to a first operating mode, receiving a touch signal generated from the touch panel and transmitting the touch signal to an image controller by the touch signal processor, and transforming the touch signal into a corresponding input signal and transmitting the input signal to a host by the image controller.

The touch display of the present invention not only can be an external screen of the computer system, but also can be simulated as the external keyboard device by the touch signal processor and the image controller, so that the user can utilize the present invention to control the host by the virtual keyboard, even through the operating system of the host does not support the virtual keyboard function. Thus, the touch display of the present invention can be switched to different operating modes according to user's demand, so as to provide functions of the conventional touch interface and the virtual keyboard interface.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a computer system according to an embodiment of the present invention.

FIG. 2 is a functional block diagram of a touch display according to the embodiment of the present invention.

FIG. 3 is a flow chard of switching the operating modes of the touch display according to the embodiment of the present invention.

### DETAILED DESCRIPTION

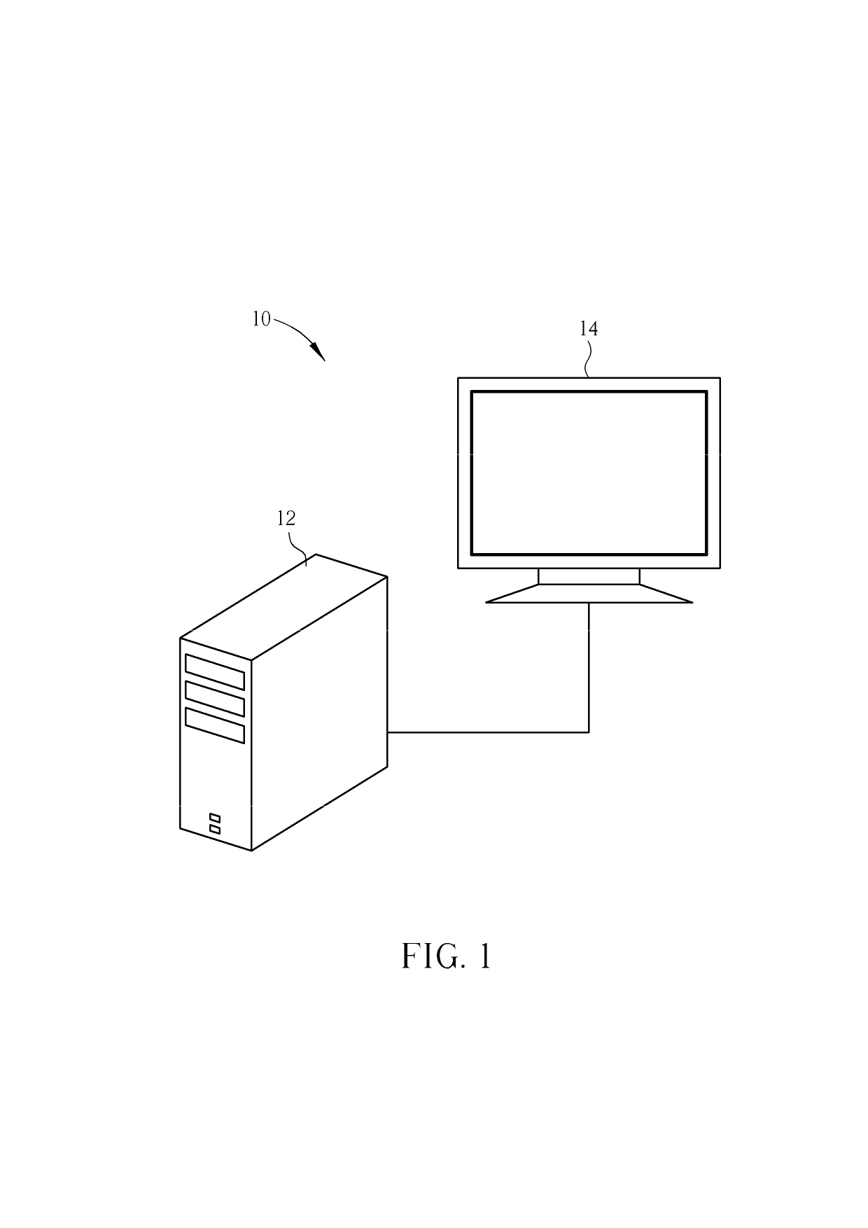

Please refer to FIG. 1. FIG. 1 is a diagram of a computer system 10 according to an embodiment of the present invention. The computer system 10 includes a host 12 and a touch display 14. The touch display 14 is electrically connected to the host 12 for displaying an image according to an image signal outputted from the host 12. Generally, the computer 10 can be applied to public place popularly, such as ATM, the tour guide machine in a train station, the network commerce machine in a convenience store, and so on. Because the computer system 10 is set in the public place, the host 12 can be hidden inside a casing for protection. A user watches the touch display 14 and controls the application program of the host 12 by an input function of the touch display 14 to search data. The computer system 10 of the present invention does not utilize an external real keyboard device, however utilizes the touch display 14 to display the virtual keyboard for simulating the real keyboard device and providing the same input function.

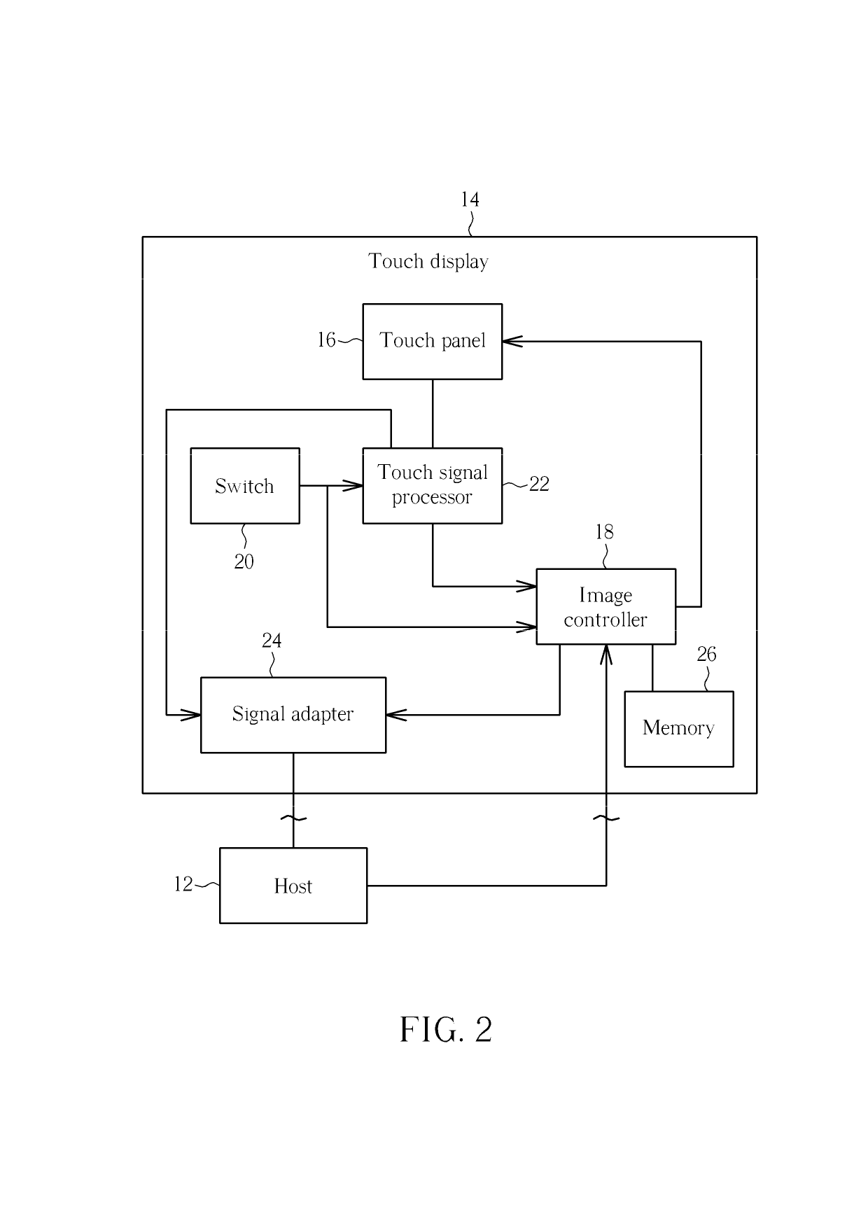

Please refer to FIG. 1 and FIG. 2. FIG. 2 is a functional block diagram of the touch display 14 according to the embodiment of the present invention. The touch display 14 includes a touch panel 16, an image controller 18, a switch 20, a touch signal processor 22 and a signal adapter 24. The touch panel 16 can be a touch screen. The touch screen not only can display the image, but also can be pressed to generate a touch signal according to the triggered area (the triggered area is a position of the touch panel 16 where the user presses). The image controller 18 is electrically connected to the touch panel 16 and the host 12. The image controller 18 can receive the image signal outputted from the host 12, such as video graphic array (VGA) signal, to drive the touch panel 16 to display the corresponding image. The switch 20 is electrically connected to the touch signal processor 22 and the image controller 18 for switching the operating modes of the touch display 14.

As shown in FIG. 1 and FIG. 2, the touch signal processor 22 can be switched to a first operating mode and to a second operating mode by the switch 20, then the touch signal processor 22 can transmit the corresponding signal to the image controller 18 and to the host 12, so that the host 12 can execute functions according to the operating mode of the touch signal processor 22. The signal adapter 24 is electrically connected to the touch signal processor 22, the image controller 18 and the host 12. The signals outputted from the touch signal processor 22 and the image controller 18 can be transmitted to the host 12 via the signal adapter 24. The touch signal processor 22 can receive the touch signal generated from the touch panel 16 and execute the function according to the operating mode.

For example, the touch signal processor 22 can directly transmit the received touch signal to the host 12 via the signal adapter 24 when being switched to the second operating mode. Further, the touch signal processor 22 can transmit the received touch signal to the image controller 18 when being switched to the first operating mode. The image controller 18 can transform the touch signal, such as complication and decoding, and then transmit the touch signal to the host 12 via the signal adapter 24. The host 12 can execute the application program according to the touch signal transmitted from the signal adapter 24, and output the image signal to the image controller 18, so the image controller 18 can drive the touch panel 16 to display the image according to the image signal.

The touch display 14 of the present invention can be switched to the touch keyboard mode (the first operating mode) and to the common touch mode (the second operating mode) according to user's demand. As the touch display 14 is switched to the first operating mode by the switch 20, the switch 20 can output an actuating signal to the image controller 18. The image controller 18 can read a virtual keyboard pattern stored in a memory 26 of the touch display 14, and drive the touch panel 16 to display the virtual keyboard pattern. The memory 26 can be electrically connected to the image controller 18. The user can watch the virtual keyboard pattern on the touch panel 16, and selectively click a button on the virtual keyboard pattern to operate the application program of the host 12. When the surface of the touch panel 16 is pressed, the touch panel 16 can generate the touch signal according to the triggered area. The touch signal can be coordinate information for recording the position of the triggered area on the touch panel 16.

In the first operating mode, the touch signal processor 22 can transmit the touch signal (the coordinate information) from the touch panel 16 to the image controller 18. Because the touch panel 16 displays the virtual keyboard pattern by the image controller 18, the image controller 18 can analyze coordinates of buttons (each button corresponds to specific character information) on the virtual keyboard pattern. The image controller 18 can read the coordinates of the touch signal, and find out the character information on the virtual keyboard pattern corresponding to the received touch signal (the coordinate information). Then, the image controller 18 can transform the touch signal (the coordinate information) into a corresponding input signal (which represents the character information), and transmit the input signal to the host 12 via the signal adapter 24, so that the host 12 can execute the application program according to the input signal.

Go into details, the image controller 18 can control a position of the virtual keyboard pattern displayed on the touch panel 16, and can analyze the coordinates of each button on the virtual keyboard pattern. For example, the coordinates (0, 1) represents the letter “A”, the coordinates (0, 2) represents the command “Enter”, and the coordinates (0, 3) represents the numeral “9”. The touch panel 16 is pressed to generate the touch signal according to the triggered area, and can transmit the touch signal to the image controller 18 via the touch signal processor 22, so as to drive identification and transformation of the image controller 18. The image controller 18 does not output any command when the image controller 18 analyzes the coordinates of the touch signal is not situated on an area of the touch panel 16 whereon the virtual keyboard pattern is displayed, which means the touch input is an invalid operation for the touch display 14. When the coordinates of the touch signal is situated on the virtual keyboard pattern, the image controller 18 can analyze what kind of button is clicked according to the coordinates of the touch signal, and transmit the input signal corresponding to the character information of the clicked button to the host 12, so that the virtual keyboard pattern displayed by the touch display 14 can be used for executing the application program of the host 12.

The touch panel 16 can display the image provided by the host 12 via the image controller 18. The virtual keyboard pattern can appear by the switch 20 when the touch display 14 is switched to the touch keyboard mode (the first operating mode). For preventing the virtual keyboard pattern displayed on the touch panel 16 from covering the original image, the virtual keyboard pattern can move its position on the touch panel 16 according to user's demand. The touch display 14 of the present invention can utilize the touch signal processor 22 to transmit the touch signal to the image controller 18. The image controller 18 controls the touch panel 16 to display the virtual keyboard pattern, so the image controller 18 can accurately analyze the coordinates of each button (the character information) on the virtual keyboard pattern. As the touch panel 16 is pressed to generate the touch signal, the touch signal processor 22 can transmit the touch signal to the image controller 18, and the image controller 18 can analyze the input signal (the character information) according to the touch signal (the coordinate information), so that the touch display 14 can be simulated as the real keyboard device for outputting the input signal to the host 12.

It should be mentioned that the touch signal processor 22 can transmit the signal to the image controller 18 via an inter-integrated circuit (I2C interface), the signal adapter 24 can receive the signal from the touch signal processor 22 and the image controller 18 via a universal serial bus (USB interface), and establish transmission with the host 12. Because the conventional real keyboard device is electrically connected to the host via the USB interface, the touch display 14 of the present invention can utilize the USB interface to establish the transmission between the signal adapter 24 and the host 12. The touch display 14 can generate the input signal according to the clicked button on the virtual keyboard pattern, which means the touch display 14 can be simulated as the real keyboard device with the USB interface. The touch display 14 of the present invention can be utilized to execute keyboard input operation even through the operating system of the host 12 does not support the virtual keyboard function.

In addition, the image controller 18 can further receive the virtual keyboard pattern from a memory of the host 12. When the touch signal processor 22 is switched to the first operating mode by the switch 20, the host 12 can analyze transformation of the operating modes via the image controller 18 and the signal adapter 24, and output the image signal (which corresponds to the virtual keyboard pattern) to the image controller 18, so as to drive the touch panel 16 to display the virtual keyboard pattern by the image controller 18. Actuating method of the virtual keyboard pattern is not limited to the above-mentioned embodiment, and depends on design demand.

Furthermore, when the touch display 14 is switched to the second operating mode by the switch 20, the touch panel 16 can generate the touch signal according to the triggered area, and the touch signal processor 22 can directly transmit the touch signal from the touch panel 16 to the host 12 via the signal adapter 24. At this time, the host 12 can receive the touch signal from the signal adapter 24, and analyze the touch signal into the predetermined standard actuating signal. For example, the coordinates (100, 100) on the touch panel 16 can be predetermined as the command “Enter”, the coordinated (100, 200) can be predetermined as the command “Cancel”. When the touch panel 16 is pressed, the touch signal processor 22 can transmit the touch signal generated from the touch panel 16 to the host 12 via the signal adapter 24, and the host 12 can determine the standard actuating signal corresponding to the received touch signal. The touch signal generated from each triggered area on the touch panel 16 has been predetermined the related standard actuating signal. The host 12 can directly analyze the signal from the signal adapter 24 to execute corresponding operation. It is to say, the image controller 18 in the second operating mode drives the touch panel 16 to display the image according to the image signal outputted from the host 12. The image controller 18 in the second operating mode does not receive the touch signal outputted from the touch signal processor 22, and not analyze the input signal (the character information) according to the touch signal.

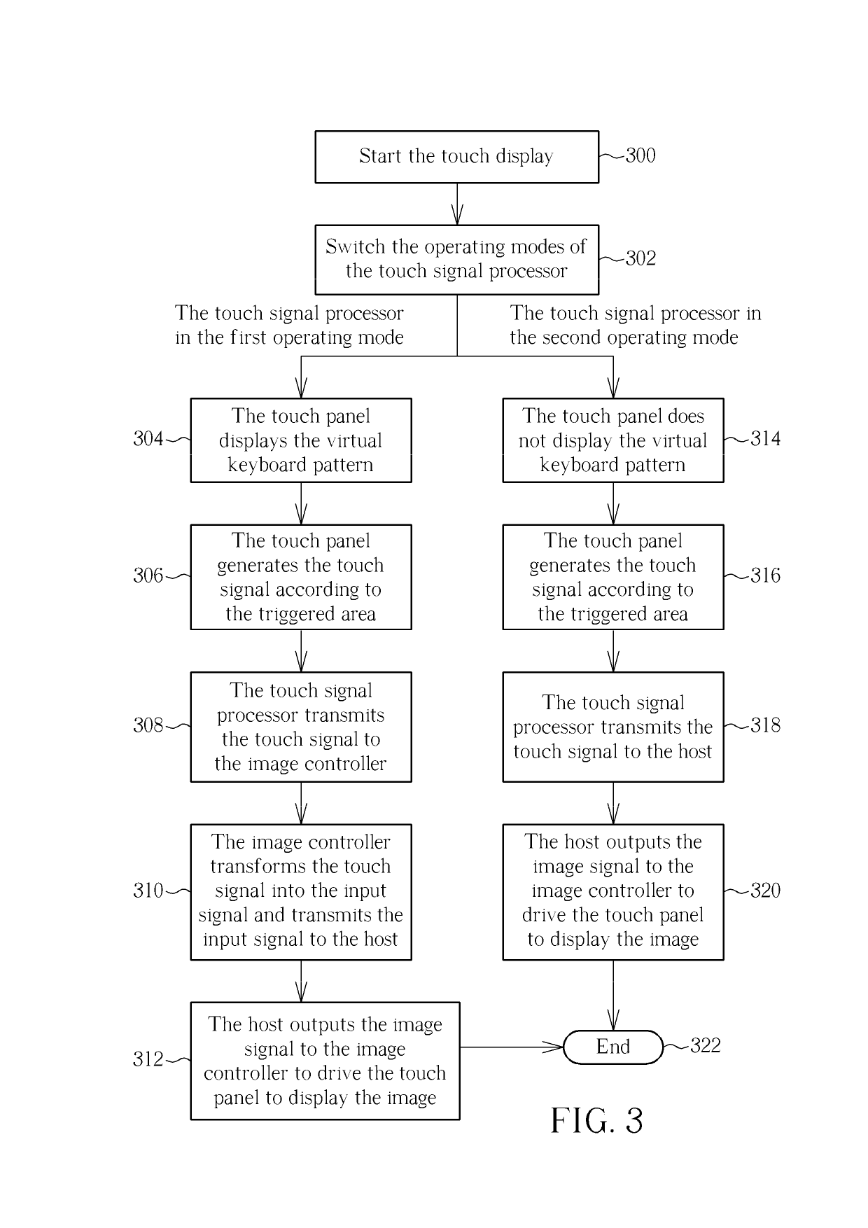

Please refer to FIG. 3. FIG. 3 is a flow chard of switching the operating modes of the touch display 14 according to the embodiment of the present invention. The method includes:

Step 300: Start the touch display 14.

Step 302: Switch the operating modes of the touch signal processor 22 by the switch 20. Execute step 304 when the touch signal processor 22 is switched to the first operating mode; Execute step 314 when the touch signal processor 22 is switched to the second operating mode.

Step 304: The image controller 18 drives the touch panel 16 to display the virtual keyboard pattern.

Step 306: The touch panel 16 generates the touch signal according to the triggered area.

Step 308: The touch signal processor 22 receives and transmits the touch signal to the image controller 18.

Step 310: The image controller 18 transforms the touch signal into the corresponding input signal, and transmits the input signal to the host 12 via the signal adapter 24.

Step 312: The host 12 outputs the image signal to the image controller 18 according to the input signal, so as to drive the touch panel 16 to display the corresponding image. Execute step 322.

Step 314: The image controller 18 does not drive the touch panel 16 to display the virtual keyboard pattern.

Step 316: The touch panel 16 generates the touch signal according to the triggered area.

Step 318: The touch signal processor 22 receives and transmits the touch signal to the host 12 via the signal adapter 24.

Step 320: The host 12 outputs the image signal to the image controller 18 according to the touch signal, so as to drive the touch panel 16 to display the corresponding image. Execute step 322.

Step 322: End.

Detailed illustration of the above-mentioned method is introduced as follows. The touch signal processor 22 is switched to the first operating mode or to the second operating mode alternatively when the touch display 14 starts. The switch 20 can be a mechanical switch as hardware, or a switch circuit as firmware. Application of the switch 20 is designed according to actual demand, and detailed description is omitted herein for simplicity. When the touch signal processor 22 is switched to the first operating mode (the touch keyboard mode), the switch 20 can output the actuating signal to the image controller 18 immediately, so as to drive the touch panel 16 to display the virtual keyboard pattern. In the meanwhile the user can click the buttons of the virtual keyboard pattern displayed on the touch panel 16. The touch panel 16 can generate the touch signal including the coordinate information of the triggered area, and transmit the touch signal to the touch signal processor 22. The touch signal processor 22 then transmits the touch signal to the image controller 18.

The image controller 18 can analyze whether the touch signal (the coordinate information) is situated on a button (the character information) of the virtual keyboard pattern. The virtual keyboard pattern can include a plurality of buttons. The buttons correspond to the different character information, such as letters of the alphabet, the numerals, and specific commands. The image controller 18 can analyze what kind of button (the character information) is clicked according to the touch signal (the coordinate information) in specific sequence. As the touch signal (the coordinate information) is not situated on the buttons of the virtual keyboard pattern, the image controller 18 can neglect the touch input operation. As the touch signal (the coordinate information) is situated on the button of the virtual keyboard pattern, the image controller 18 can generate the input signal corresponding to the button (the character information on the virtual keyboard pattern). The input signal can be simulated as an input command of the external keyboard device, and can be transmitted to the host 12 to execute the application program of the host 12. Due to execution of the host 12, the host 12 can selectively output the image signal to the image controller 18 for driving the touch panel 16 to display the corresponding image.

The touch signal processor 22 can be switched to the second operating mode (the common touch mode) for closing the virtual keyboard function. The present invention stops transmission between the touch signal processor 22 and the image controller 18, and the touch signal processor 22 can transmit the touch signal from the touch panel 16 to the host 12 via the signal adapter 24. The standard actuating signal corresponding to the coordinates of the touch panel 16 has been predetermined by the application program of the host 12, as the above-mentioned embodiment. The host 12 can receive and analyze the touch signal into the standard actuating signal, so as to execute the corresponding application program. The host 12 can neglect the touch input operation as the touch signal does not correspond to the standard actuating signal. The host 12 can execute the operation according to the touch signal as the touch signal corresponds to the predetermined standard actuating signal, and further selectively drive the image controller 18 to replace the image displayed on the touch panel 16.

In conclusion, the touch display of the present invention can be switched to the touch keyboard mode and to the common touch mode according to user's demand. The touch display in the common touch mode can be an ordinary guide/commerce machine. The host analyzes the touch signal generated from the touch panel and executes the operation by the actuating signal corresponding to the received touch signal, which means the touch display switched to the common touch mode (the second operating mode) is the guide/commerce machine specially for showing image, the touch signal generated from the touch panel is transmitted to the host without transformation, and the host can analyze the touch signal (coordinate information) into the predetermined standard actuating signal, so as to execute the corresponding operation.

The touch display in the touch keyboard mode can be simulated as the real keyboard device electrically connected to the host by the USB interface, and the operating system of the host does not support the virtual keyboard function. The touch display switched to the touch keyboard mode (the first operating mode) can drive the touch panel to display the virtual keyboard pattern. When the button of the virtual keyboard pattern is clicked, the touch signal processor can transmit the touch signal generated from the touch panel to the image controller. The image controller can analyze and transform the touch signal (the coordinate information) into the input signal (the character information) corresponding to the clicked button, then the host can receive the input signal to execute the corresponding application program. Therefore, the touch display of the present invention can be applied to the host that installs the operating system without the virtual keyboard function, to effectively increase integration of the commercial computer system.

Comparing to the prior art, the touch display of the present invention not only can be an external screen of the computer system, but also can be simulated as the external keyboard device by the touch signal processor and the image controller, so that the user can utilize the present invention to control the host by the virtual keyboard, even through the operating system of the host does not support the virtual keyboard function. Thus, the touch display of the present invention can be switched to different operating modes according to user's demand, so as to provide functions of the conventional touch interface and the virtual keyboard interface.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A touch display comprising:
a touch panel for generating a touch signal according to a triggered area on the touch panel;
an image controller electrically connected to the touch panel for receiving an image signal outputted from a host and driving the touch panel to display a corresponding image;
a switch; and
a touch signal processor electrically connected to the touch panel, the image controller and the switch, the touch signal processor being switched to a first operating mode and to a second operating mode by the switch, the touch signal processor receiving the touch signal and transmitting the touch signal to the image controller and to the host according to the operating mode.

2. The touch display of claim 1, further comprising:
a signal adapter electrically connected to the touch signal processor, the image controller and the host.

3. The touch display of claim 2, wherein the touch signal processor transmits the touch signal to the image controller in the first operating mode, the image controller transforms the touch signal into a corresponding input signal, and transmits the input signal to the host via the signal adapter.

4. The touch display of claim 3, wherein the image controller is electrically connected to the switch for driving the touch panel to display a virtual keyboard pattern when the touch signal processor is switched to the first operating mode.

5. The touch display of claim 4, further comprising:
a memory electrically connected to the image controller, the memory storing the virtual keyboard pattern.

6. The touch display of claim 4, wherein the touch signal is coordinate information, and the input signal is character information corresponding to the virtual keyboard pattern.

7. The touch display of claim 2, wherein the touch signal processor transmits the touch signal to the host via the signal adapter in the second operating mode.

8. A computer system comprising:
a host for outputting an image signal; and
a touch display for displaying an image according to the image signal outputted from the host, the touch display comprising:
a touch panel for generating a touch signal according to a triggered area on the touch panel;
an image controller electrically connected to the touch panel for receiving the image signal and driving the touch panel to display the image;
a switch; and
a touch signal processor electrically connected to the touch panel, the image controller and the switch, the touch signal processor being switched to a first operating mode and to a second operating mode by the switch, the touch signal processor receiving the touch signal and transmitting the touch signal to the image controller and to the host according to the operating mode;
wherein the host outputs the image signal corresponding to the touch signal to the image controller.

9. The computer system of claim 8, wherein the touch display further comprises:
a signal adapter electrically connected to the touch signal processor, the image controller and the host.

10. The computer system of claim 9, wherein the touch signal processor transmits the touch signal to the image controller in the first operating mode, the image controller transforms the touch signal into a corresponding input signal, and transmits the input signal to the host via the signal adapter.

11. The computer system of claim 10, wherein the image controller is electrically connected to the switch for driving the touch panel to display a virtual keyboard pattern when the touch signal processor is switched to the first operating mode.

12. The computer system of claim 11, wherein the touch display further comprises:
a memory electrically connected to the image controller, the memory storing the virtual keyboard pattern.

13. The computer system of claim 11, wherein the touch signal is coordinate information, and the input signal is character information corresponding to the virtual keyboard pattern.

14. The computer system of claim 9, wherein the touch signal processor transmits the touch signal to the host via the signal adapter in the second operating mode.

15. The computer system of claim 8, wherein an operating system of the host does not support a virtual keyboard function.

16. A method of switching operating modes of the touch display, the method comprising:
switching a touch signal processor to a predetermined operating mode;
displaying a virtual keyboard pattern on a touch panel when the touch signal processor is switched to a first operating mode;
receiving a touch signal generated from the touch panel and transmitting the touch signal to an image controller by the touch signal processor; and
transforming the touch signal into a corresponding input signal and transmitting the input signal to a host by the image controller.

17. The method of claim 16, further comprising:
outputting an image signal to the image controller according to the input signal by the host; and
driving the touch panel to display an image according to the image signal by the image controller.

18. The method of claim 16, wherein the touch signal is coordinate information, and the input signal is character information corresponding to the virtual keyboard pattern.

19. The method of claim 16, wherein the image controller does not drive the touch panel to display the virtual keyboard pattern when the touch signal processor is switched to a second operating mode.

20. The method of claim 19, wherein the touch signal processor receives the touch signal generated from the touch panel, and transmits the touch signal to the host via a signal adapter.
